(19) United States
(12) Patent Application Publication
(10) Pub. No.: US 2007/0182163 A1
(43) Pub. Date: Aug. 9, 2007

(54) Method and device for de-icing of trains

(76) Inventor: Thomas Jemt, Vallingby (SE)

Correspondence Address: CHARLES E. BAXLEY, ESQ., 90 JOHN STREET, THIRD FLOOR, NEW YORK, NY, 10038, US

(21) Appl. No.: 11/346,984

(22) Filed: Feb. 3, 2006

(51) Int. Cl. B60B 39/00

(52) U.S. Cl. 291/2

(57) ABSTRACT

Method and device for de-icing of trains in which a treatment medium is sprayed against the underside of units in the train such as locomotive and carriages in order to remove ice which has been built up in the base frames of the units. As treatment medium heated glycol is used.

The present invention relates to a method and device for de-icing of trains, wherein a medium is sprayed against the underside of the units in the train such as locomotive and carriages in order to remove ice which has been built up on the base frames of the units.

When trains are run during wintry conditions disturbances are often seen due to formation of ice around the brakes and bogie. With conventional de-icing systems it is today a constant problem with trains which have to be removed from service due to ice formation.

On a standard size train it takes about 10 hours to remove the ice which requires enormous quantities of energy with blowing hot air. In this conventional de-icing moisture always remains on all parts under the train. When the train thereafter runs out in degrees below freezing point ice crystals are formed immediately under the entire train. These have a pointed and spiny form in its structure which means that the snow immediately clings to them and starts to build up the ice. This combination with heated brakes and quick cooling means that the train quickly builds up the ice again.

The object of the invention is to provide a de-icing system in which the drawbacks of the conventional de-icing are eliminated.

This object is achieved in that the method and the device are characterized according to the following claims.

The invention will in the following be described in connection with an embodiment of a device for de-icing of trains shown in the drawings.

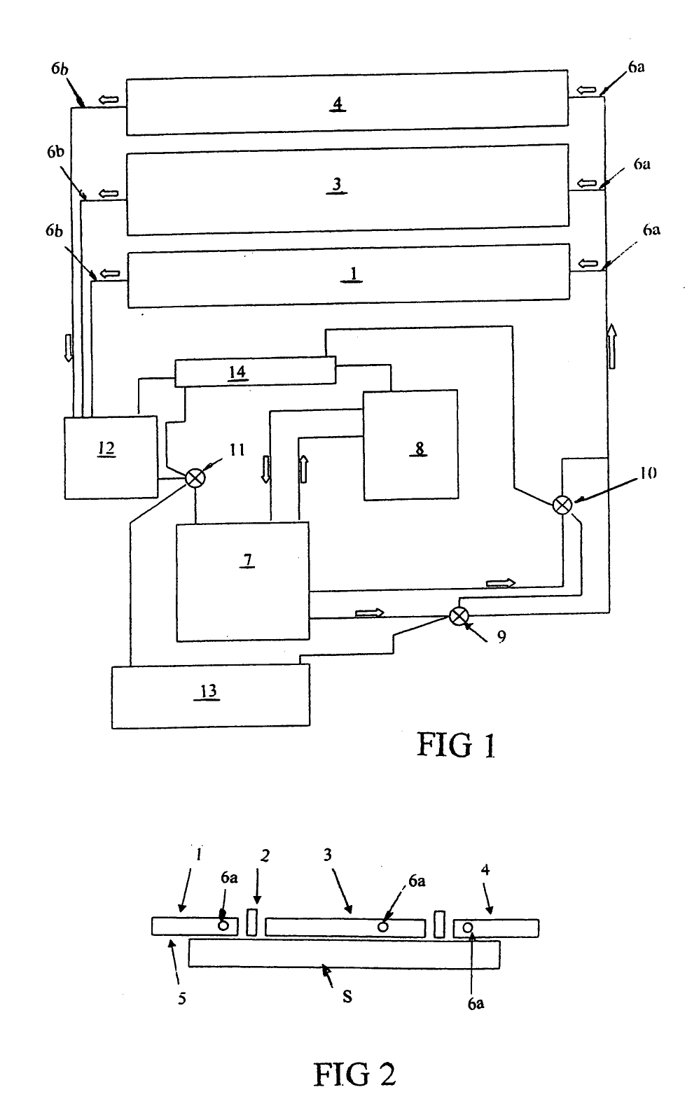

FIG. 1 is schematically a flow chart of the device.

FIG. 2 is a cross section through collecting tanks in the device and arranged on a track.

The device illustrated in FIGS. 1 and 2 comprises a collecting tank 3 designed to be arranged between the rails 2 in the de-icing area of a railway track and a collecting tank 1 to the left and a collecting tank 4 to the right of the rails 2. The tanks 1, 3 and 4 thereby have a length of e.g. 15 meters and are bolted to the sleepers S of the track by means of wood screws. The tank 1 has a width such as it lies between and with suitable space to the rails, while the tanks 3 and 4 also lie with a space to the rails and have a width such as to extend outside of the outer side of the train carriages. At the ends of the collecting tanks 1, 3 and 4 are connections 6a for the supply and 6b for the evacuation of a de-icing medium to and from the tanks.

According to the invention the de-icing medium is a hot glycol which is sprayed on the under sides of the train carriages via a number of nozzles or mouthpieces arranged on the edges of the tanks 1, 3 and 4 e.g. 30 nozzles on the length 15 meters. The glycol is stored in a tank 7 from which it is delivered to an oil pan or electric pan 8 for heating to approximately 90°. From the tank 7 the glycol is pumped via pumps 9, 10 to the connections 6a and nozzles (not shown) of the tanks 1, 3 and 4 in a continuous flow of glycol which is ejected from the tanks 1, 3 and 4. The heated tanks melt the falling ice on the way towards the connections 6b of the tanks. The evacuated glycol is supplied to a recirculation system 12 which cleans it in order to be used again in the device via a return pump 11 which returns the glycol to the tank 7. A power supply unit 13 is coupled to the pumps 9-11 and a control module controls the function of the pan 8, the pumps 9-11 and the recirculation system 12.

The glycol used is propylenglycol which is not inflammable, poisonous or lengthy noxious to the environment. By using propylenglycol there is no formation of ice crystals under the train but instead one gets a slightly remoistured and somewhat “sticky” surface in which the snow does not easily adhere and this means that ice formation beneath the train is prevented in a very efficient way. Another very big advantage is the time factor. With present de-icing plants it can today take nearly 10 hours to de-ice a train with enormous consumption of energy. In the plant according to the invention the train runs in about 10 minutes above the plant with a speed of about 25 meters per minute and with very low consumption of energy.

If the plant (device) is used regularly in a preventive purpose on trains free from ice which shall run in areas with much snow this will prevent formation of ice in a very efficient way. With the system according to the invention it will thus be possible to run the trains during winter time without operation disturbances due to formation of ice around breaks and bogie. The plant shown may be placed anywhere along the track outdoors, it requires only support of current and is for the rest entirely self supporting and automatic.

1. Method for de-icing of trains wherein a treatment medium is sprayed against the underside of the units of the train such as locomotive and carriages in order to remove ice which has been built up on the base frame of the units, characterized in that heated glycol is used as treatment medium.

2. Method according to claim 1, characterized in that the sprayed glycol is collected in order to be cleaned and re-used in the system.

3. Method according to claim 1 or 2, characterized in that the treatment medium is heated to 90° C.

4. Method according to claim 1, 2 or 3, characterized in that the glycol is polypropylenglycol.

5. Method according to any of claims 1-4, characterized in that the glycol is collected in a collecting area beneath the train in which area the removed ice is melting on the way to a evacuation of the glycol.

6. Device for performing the method according to the claims 1-5, for de-icing of the units such as locomotive and carriages forming part of a train on track, characterized in that collecting tanks (1,3,4) are arranged between and on both sides of the rails (2) of the track along a part of the track in such a way that from the units of the train downpouring heated glycol sprayed against the train is collected together with removed ice.

7. Device according to claim 6, characterized in that the collecting tanks (1,3,4) have connections (6a,6b) for supply and evacuation of glycol in a constant flow, whereby the evacuated glycol is supplied to a recirculation system (12) for cleaning and re-use of the glycol.

8. Device according to claim 6, characterized of a heating source (8) for heating of the glycol before supply to the tanks (1,3,4)
